(19) United States
(12) Patent Application Publication
(10) Pub. No.: US 2021/0239728 A1
(43) Pub. Date: Aug. 5, 2021

(54) IMPROVEMENTS RELATING TO DETECTION OF PHYSICAL PERFORMANCE

(71) Applicant: Mark Raymond FISHER, Wacol, Brisbane, Queensland (AU)

(72) Inventor: Mark Raymond FISHER, Wacol, Brisbane, Queensland (AU)

(21) Appl. No.: 17/049,086

(22) PCT Filed: Apr. 18, 2019
(86) PCT No.: PCT/AU2019/050355

§ 371 Date: Oct. 20, 2020

(30) Foreign Application Priority Data
Apr. 20, 2018 (AU) 2018901314

(51) Int. Cl. G01P 5/24; A63B 69/00; G01P 13/04; A63B 24/00

(52) U.S. Cl. CPC G01P 5/24; A63B 69/00; A63B 2220/76; A63B 24/0021; A63B 2220/802; G01P 13/045

(57) ABSTRACT

A method of setting up gates for athletes in a sports training area. The gates are positioned relative to each other using signals between the gates, typically in consecutive pairs. Performance parameters such as speed and agility of the athletes can then be determined. The signals enable time-of-flight measurements and therefore distance measurements between the gates which enable the relative positioning. Signals are typically but not necessarily ultrasound. Required positions of a plurality of gates are first laid out by the user as a screen pattern on a supervisory device. A method of determining wind speed between sports training gates using ultrasound signals is also provided to enable more accurate detection of athlete performance.

This invention relates to devices for detecting physical performance of athletes, in particular but not only to methods for positioning of marker devices or sports training gates such as described in WO 2016/101023. The invention further relates to determining wind speed between gates.

### BACKGROUND TO THE INVENTION

Sports training is becoming increasingly sophisticated in many different ways. A range of devices and methods are now used for detecting the performance of athletes and thereby providing useful data to coaches. Electronic timing gates for agility testing have been known for many years although the setting out of gates has generally been done in an approximate fashion.

### SUMMARY OF THE INVENTION

It is an object of the invention to provide improved methods for setting out gates such as described in WO 2016/101023 or at least to provide a useful choice for coaches.

In one aspect the invention resides in a method of setting up gates in a sports training area. Including the steps of: a) placing a first gate at a first required position in the training area, b) placing a second gate at an initial position in the training area, c) measuring signals between the gates, d) determining current position of the second gate in relation to a second required position according to the measured signals, e) determining whether the current position of the second gate is sufficiently close to the second required position, and f) providing guidance for user relocation of the second gate toward the second required position.

The method further includes g) determining that the current position of the second gate is not sufficiently close to the second required position, and h) providing further guidance for user relocation of the second gate toward the second required position. In some cases, also i) repeating steps g) and h) in claim 2 until the second gate is sufficiently close to the second required position. In the case of multiple gates j) treating each further gate as the second gate in steps a) to i), and k) treating the first gate in steps a) to i) as the last positioned gate.

Preferably the signals enable time-of-flight measurements and therefore distance measurements between the gates. In one embodiment the signals are ultrasound. In another embodiment the signals may be LED laser signals. Preferably the guidance is provided as visual or aural cues on the second gate or on a supervisory device. The required positions of a plurality of gates are preferably laid out by the user as a screen pattern on the supervisory device.

The invention also resides in a method of determining wind speed between sports training gates. Including the steps of: setting up first and second gates in a training area, communicating by wireless between the gates and a supervisory device, timing an ultrasound signal from the first gate to the second gate, timing an ultrasound signal from the second gate to the first gate, communicating timing data by wireless from either or both gates to the supervisory device, calculating wind speed between the gates according to the timing data and distance between the gates.

Further, setting up a third gate in the training area in relation to the first and second gates, communicating by wireless between the first and third gates and the supervisory device, timing an ultrasound signal from the first gate to the third gate, timing an ultrasound signal from the third gate to the first gate, communicating timing data by wireless from either or both first and third gates to the supervisory device, calculating wind speed between the first and third gates according to the timing data and distance between the first and third gates. A wind speed vector can then be determined according to the wind speed between the first and second gates and the wind speed between the first and third gates, and the angle between the gates when using ultrasound.

Preferably the timing data is corrected based on air temperature data measured at the gates.

The invention also resides in a supervisory device and/or a set of gates which enables positioning of training gates or measurement of wind speed according to any of the preceding methods.

### LIST OF FIGURES

Preferred embodiments of the invention will be described with respect to the drawings, in which:

FIG. 1 shows an arrangement of sectors for detecting an athlete near a gate,

FIG. 2 shows an athlete on a trajectory around the gate,

FIG. 3 shows calculation of data points for the sectors,

FIG. 4 shows a set-up gate in relation to a master gate,

FIG. 5 shows responses of the set-up and master gate,

FIG. 6 shows a layout of several gates on a screen for agility testing of athletes,

FIG. 7 shows a first set-up gate being positioned in the layout of FIG. 6,

FIG. 8 outlines a user process for positioning the gates,

FIG. 9 outlines a process for positioning a particular gate,

FIG. 10 provides more detail of the gate positioning process,

FIG. 11 shows how wind speed may be calculated between two gates,

FIG. 12 shows how wind speed and direction may be calculated,

FIG. 13 shows schematic components of a typical gate,

FIG. 14 shows a gate mounted on a tripod, and

FIG. 15 shows a typical layout of external features.

### DESCRIPTION OF PREFERRED EMBODIMENTS

Referring to the drawings it will be appreciated that the invention can be performed in a variety of ways for a variety of different marker devices or gates and a range of different athletic activities. Different types of transceivers or signals, or individual transmitters and sensors might be used. The embodiments described here are given by way of example only.

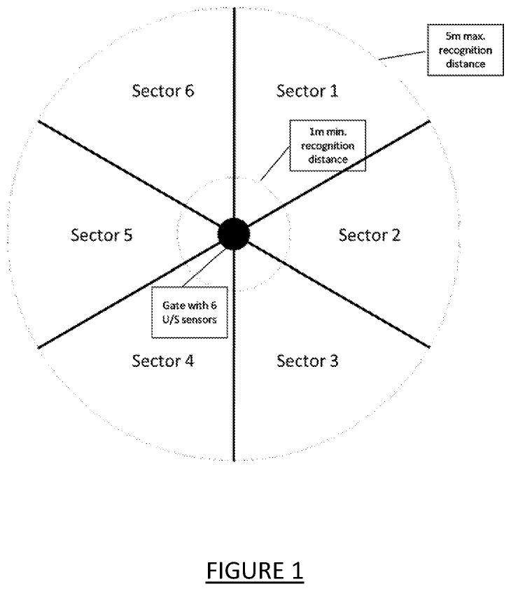

FIG. 1 shows a typical arrangement of sectors around a gate as described in WO 2016/101023. In this example there are six sectors provided by six ultrasound transceivers covering 360 degrees around a vertical axis, mounted on a post or cone, positioned in a training area. The gate communicates via wifi, bluetooth or similar with a supervisory device such as an ipad. Gates also include visible and/or audible indicators for use during set-up by a coach and for guidance to athletes during tests. Gates typically also include a magnetometer to enable orientation of the sectors and any visual indicators.

The transceivers include transmitters and sensors which can detect an athlete within a sector of 60 degrees and about 1-5 m of the gate. The sample rate of the transceivers is adjusted to allow a return echo from the target. In a standard atmosphere sound travels at approximately 34 cm/ms. This equates to an out and return time to a 5 m target at approximately 30 ms. Some overhead must be allowed, for the dynamics of the ultrasonic transducer, which increase this time by approximately another 10-25 ms dependent on the transducer implemented in the device.

In one embodiment the sample rate of the transceivers may be about 20 Hz (50 ms) when no athlete is detected, about 25 Hz (40 ms) when an athlete is detected at 5 from the gate and about 83 Hz (12 ms) when an athlete is detected at 1m from the gate. Ultrasound transceivers may be chosen in order to reduce cost compared with LED transceivers or Optical Time of Flight sensors for example.

The gate contains a processor which activates the transceivers simultaneously or in sequence so that all sectors are scanned with a maximum detection delay of up to about 300 ms (ie. 6×50 ms). Once an athlete is detected in a particular sector only this sector and the two adjacent sectors are scanned. A maximum delay of about 120 ms (ie. 3×40 ms) is preferred at 5 m with a maximum delay of about 36ms (ie. 3×12 ms) at 1 m.

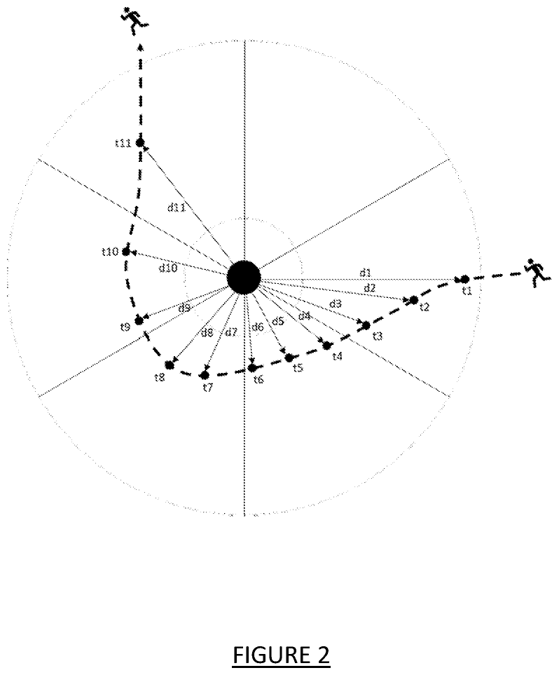

FIG. 2 shows data collection at a typical gate as an athlete moves along a trajectory in a training area. A raw data set containing 11 records is collected. Each record includes sector, timestamp (t1-t11) and distance (d1-d11) to the gate information which is then sent by wireless to the supervisory device, typically in the hands of a coach who is tracking the progress of a particular athlete.

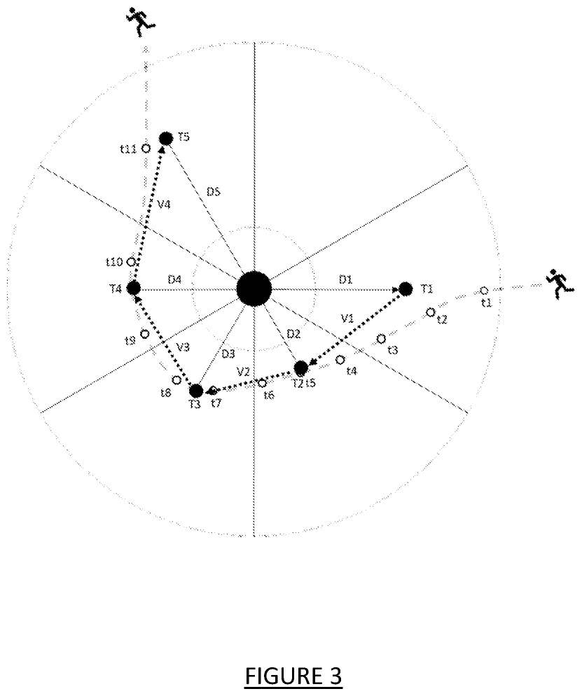

FIG. 3 indicates how the raw data may be processed either at the gate or by the supervisory device. The raw data is used to calculate an average distance (D1-D5) and time (T1-T5) on the centreline of each sector. Velocities (V1-V5) may then be calculated for travel between the sectors.

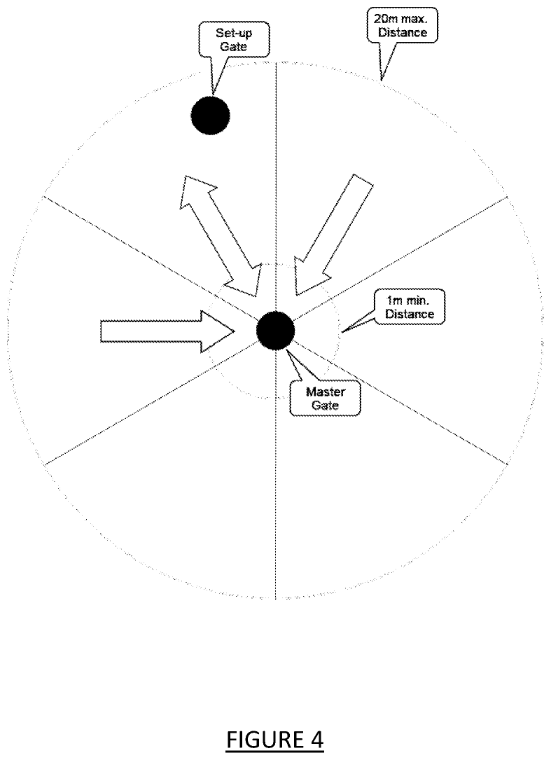

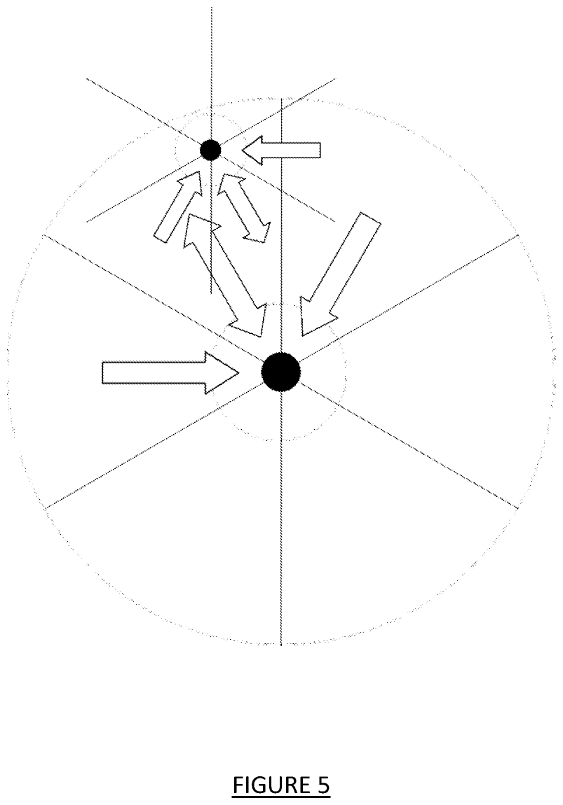

FIGS. 4 and 5 show generalised interactions between a master/reference gate and a set-up gate when a series of gates are being laid out in an agility testing pattern for athletes. The gates are typically set apart at distances of between 1 m and 20 m. The master gate and set-up gate communicate with each other by sending and detecting ultrasound signals, and communicate with the supervisory device via wireless.

In the example of FIG. 4 the master gate sends an ultrasound signal or “ping” in all sectors until a response “ping” is received from the set-up gate. Once a response is received further signals are sent only in the relevant sector. In FIG. 5 the set-up gate responds to the master gate with a ping after a fixed delay. The set-up first listens in all sectors and then only in the relevant sector and adjacent sectors once a ping is received.

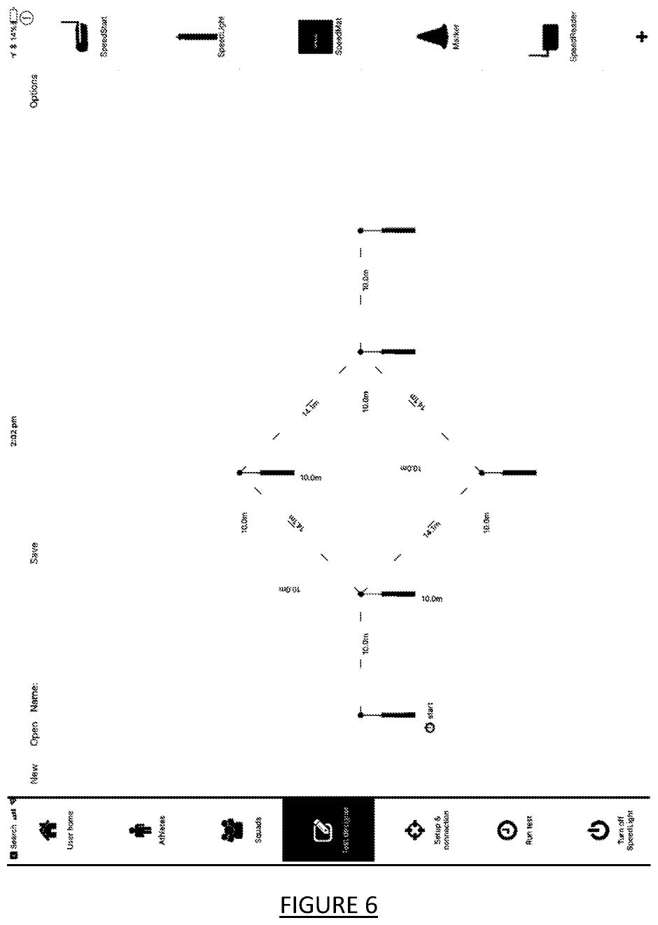

FIG. 6 shows a touchscreen from the supervisory device, as used by a coach when laying out a pattern of timing (“Speedlight”) gates, for example. A software application on the supervisory device communicates via wireless with the gates. The coach intends to create a pattern having four gates positioned along an easterly line with spacing of about 10 m and having two central gates positioned about 10 m north and south of the line. Athletes are typically guided around the pattern by visible and/or audible indicators on the gates so that speed, agility or other abilities of the athletes can be estimated.

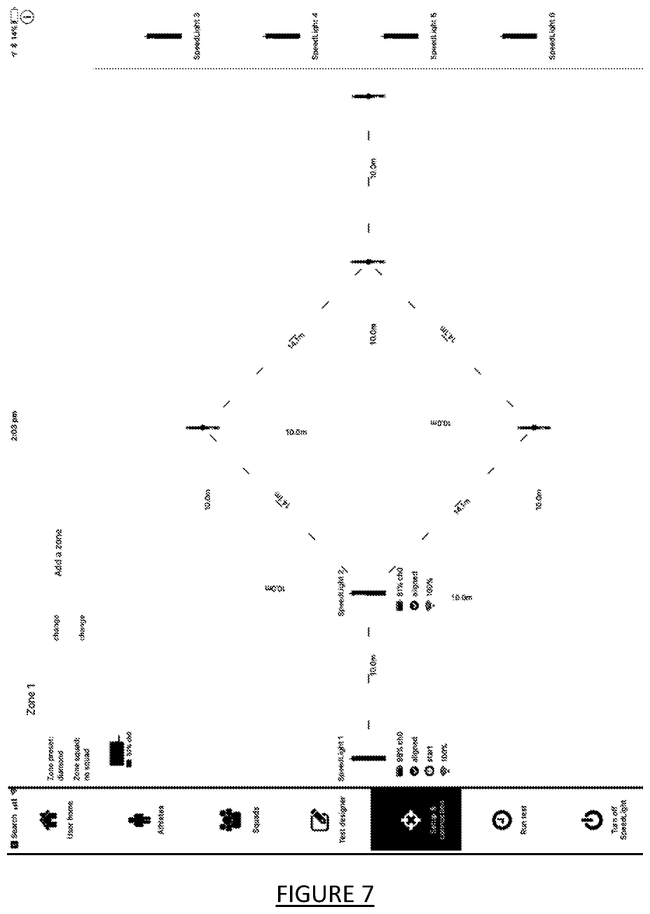

FIG. 7 shows the screen of the supervisory device as the first two gates are being laid out in the pattern from FIG. 6. Gate 1 provides the master gate in this example while gate 2 is a set-up gate being positioned and aligned with respect to Speedlight 1. Gate 2 then becomes the master gate. Gate 3 is next to be positioned at either the North or South location with respect to gate 2, followed by gate 4, and so on to gate 6. In general, an ipad or similar device causes visible or audible cues for the user to be emitted by the gates.

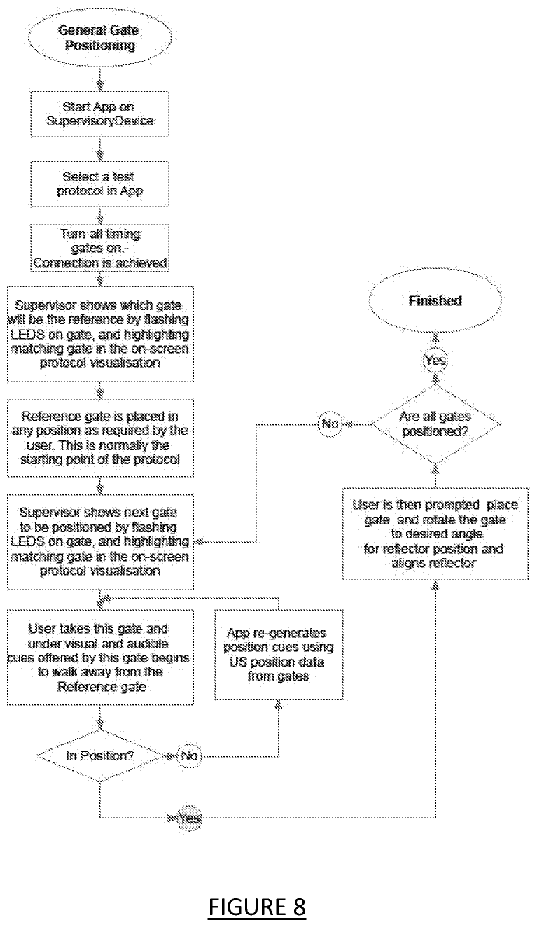

FIG. 8 outlines a general routine by which a user positions a set-up gate in relation to a master or reference gate. The user first starts the application on the supervisory device and selects a test pattern or creates a new pattern, similar to FIG. 6 for example. All gates in the system are turned on and controlled via wireless and may flash or beep. The user selects and places the first reference gate in position and confirms or checks on screen, followed by the first set-up gate. Alternatively the device selects the physical gates and provides cues for the user for positioning a orientation.

The user orients and lifts the required gates and walks to their required positions following cues provided on screen by the supervisory device and/or on the gates themselves. Gates can typically be positioned by the user to within about 2 cm of the on screen pattern, or better. The gates communicate pings via ultrasound, in this example, as described in relation to FIGS. 4 and 5, typically within a maximum spacing of about 10 m. The subsequent reference and set-up gates are selected by the device according to the spacing of gates required in the pattern. In some cases the gates may include a retro-reflective photo-switching device which require an opposing reflector and require orientation in the overall pattern. This retro-reflective switch gives an accurate time when an athlete breaks the beam.

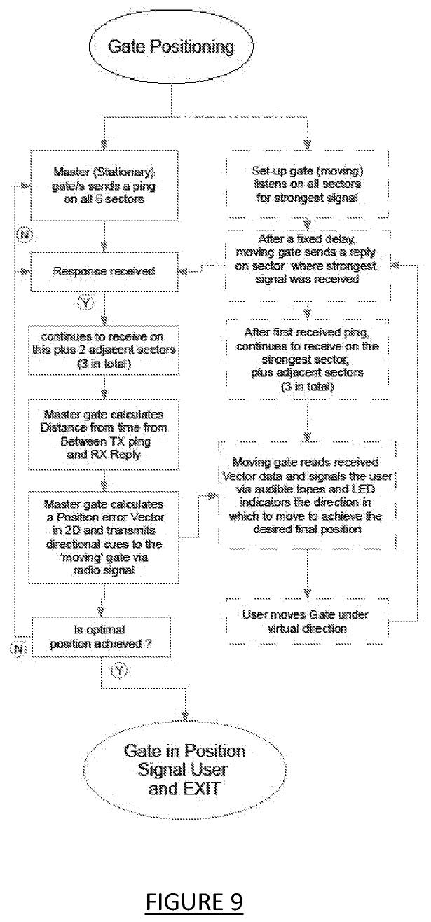

FIG. 9 outlines a more detailed process between master and set-up gate, in relation to FIG. 6 for example. The master gate “pings” with ultrasound on all sectors until a response is received from the set-up gate. Similarly the set-up gate listens on all sectors until the first ping is received. The set-up gate returns a ping to the master gate which times the exchange and then calculates distance between the gates. Fixed delays are taken into account. Air temperature may be measured at each gate and a temperature correction may be applied to allow for variations in the speed of sound. The user then orients and places the gates under direction of the supervisory device.

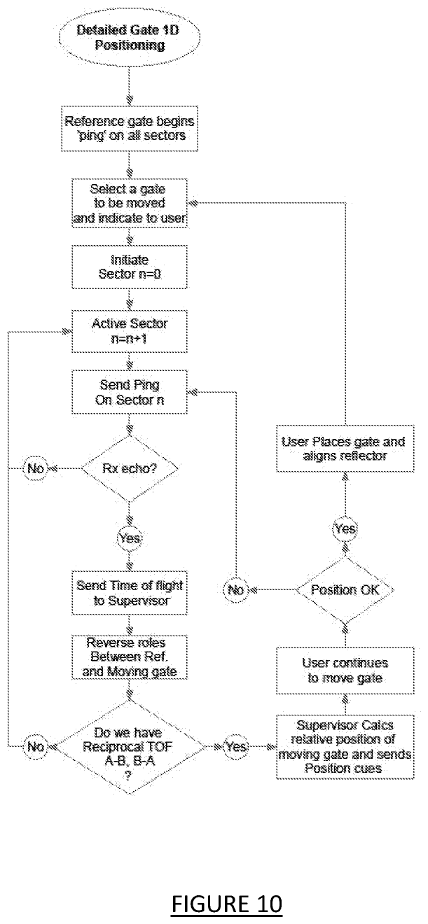

FIG. 10 provides detail on the ping process between master/reference gate and set-up gate. Orientation of the sectors on a particular gate are determined by way of the magnetometer. The sectors are then pinged in sequence and any reply or echo is used to determine time of flight and therefore current distance between the pair of gates. Cues are provided for the user to move the gate according to the pattern, as described above. Data is read from the magnetometer by the processor and visible cues are provided for the user to rotate the gate if the photoelectric sensors and reflectors are being utilized.

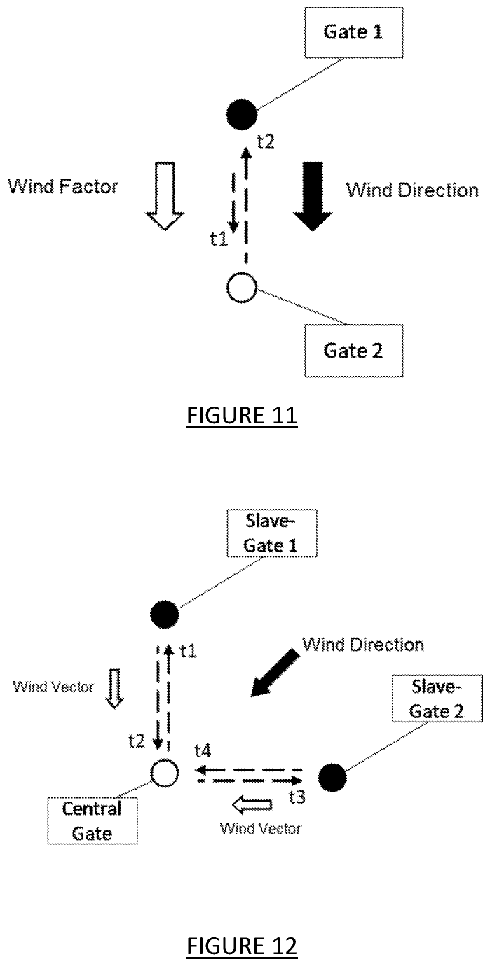

FIG. 11 shows how wind speed may be determined between a pair of gates, in order to provide a measure of tail wind or head wind, when testing an athlete. The position and therefore distance between gates 1 and 2 is known in this example, although any delays such as wifi latencies must still be determined. Under control of the supervisory device, gate 1 sends an ultrasound ping to gate 2 and the time t1 is determined. After a delay, gate 2 is then instructed to send an ultrasound ping to gate 1 with measurement of the return time t2. These events are communicated to the device by wifi and repeated until a statistical distribution of times in each direction has been recorded. A median function is then applied to the distributions of t1 and t2. The difference between median times provides a measure of wind speed in either direction.

FIG. 12 shows further how both wind speed and direction may be determined by three gates. The position of all gates is known and they are under control of the supervisory device. A central gate sends ultrasound pulses to slave gates 1 and 2, and times t1 and t3 are measured. The slave gates are instructed to send pulses to the central gate, and times t2 and t4 are measured. The measurements are repeated to obtain statistical distributions so that delays caused by latencies in the system can be eliminated. The median times are then determined with the median difference between t1 and t2 providing the wind speed between central and slave 1 while the median difference between t3 and t4 provides the wind speed between central and slave 2. Wind vectors can then be determined as shown.

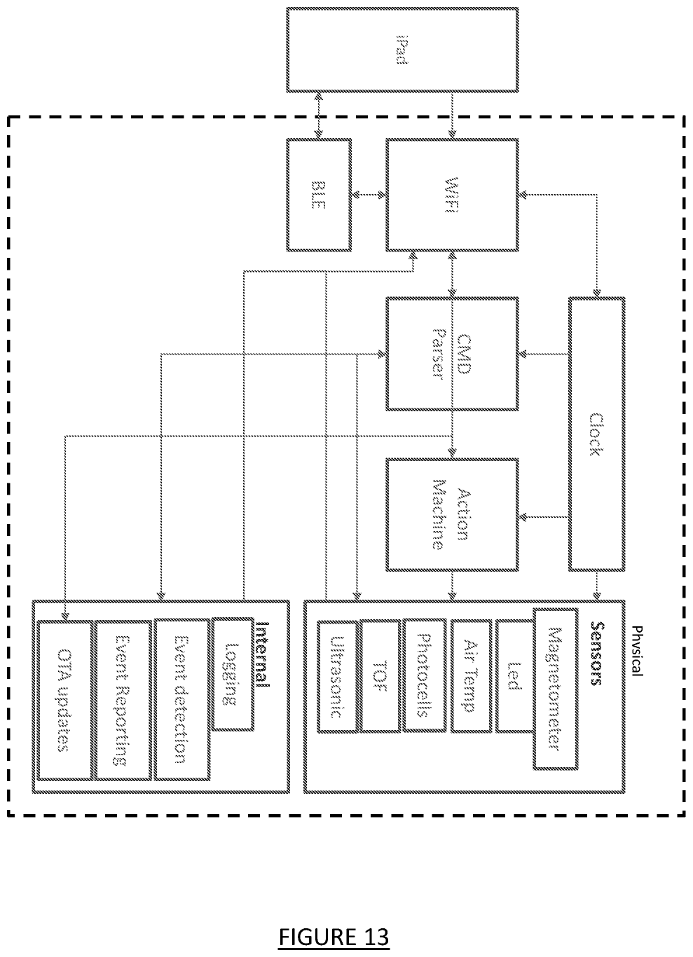

FIG. 13 shows components in a typical gate that could be used in the methods of this invention. These include a processor which carries out a range of functions including command parsing (CMD), actioning instructions, detecting events, and logging data in a memory. The processor also interacts with an load by way of Wifi or Bluetooth. Physical sensors include ultrasound and optical transceivers, magnetometer, air temperature. Other components are LED indicators and a speaker for user guidance, a battery and a system clock.

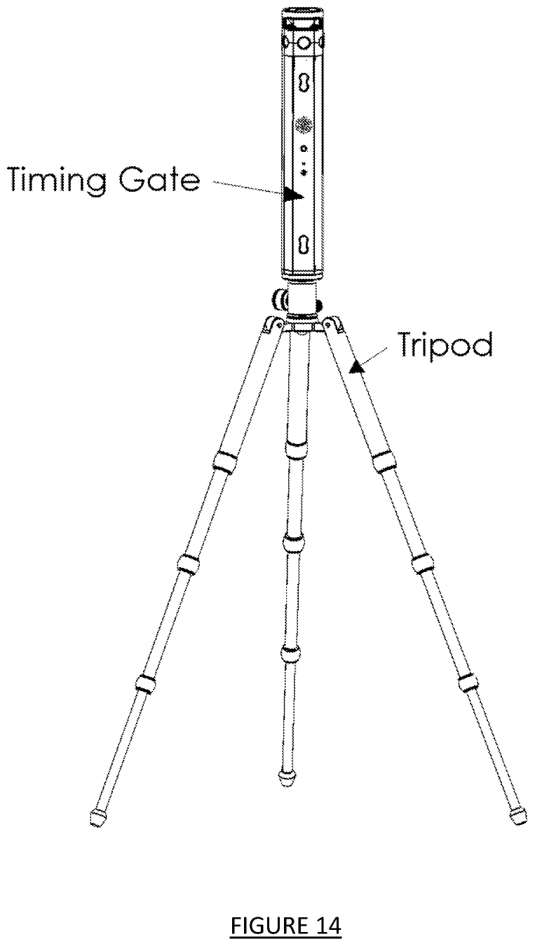

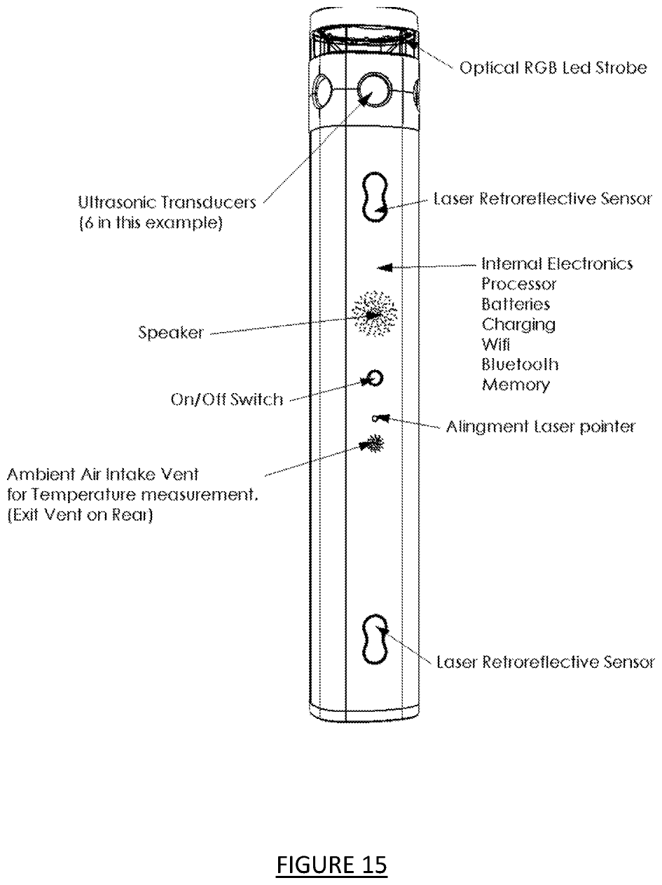

FIG. 14 shows how a sports training and testing gate may be mounted on a tripod and thereby located in a training area. FIG. 15 indicates how a range of the components in FIG. 13 may be located on external parts of the gate for interaction with users, athletes and the training environment.

1-17. (canceled)

18. A method of setting up a pattern of gates in a sports training area, including:
selecting or creating the pattern onscreen using a supervisory device,
activating the gates from the supervisory device,
starting layout of the pattern by placing a first gate at a first required position in the training area,
walking a second gate to an initial position in the training area,
measuring ultrasound signals between the gates to determine distance between the gates,
determining current position of the second gate in relation to a second required position according to the measured signals,
determining whether the current position of the second gate is sufficiently close to the second required position,
providing guidance via the supervisory device for user relocation of the second gate toward the second required position, and
placing the second gate at the second required position to form part of the pattern.

19. The method according to claim 18, further including:
determining that the current position of the second gate is not sufficiently close to the second required position, and
providing further guidance for user relocation of the second gate toward the second required position.

20. The method according to claim 19, further including:
repeating the determining and providing steps until the second gate is sufficiently close to the second required position.

21. The method according to claim 18, further including laying out a plurality of gates in the pattern by:
treating each further gate as the second gate, and
treating the first gate as the last placed gate.

22. The method according to claim 18, wherein the guidance is provided as visual or aural cues on the second gate, or on the supervisory device.

23. The method according to claim 18, further including receiving timing data from at least some of the gates in the pattern, and calculating wind speed vectors between two or more of the gates.

24. A supervisory device containing a software application, wherein the software application includes instructions which enable the device to:
lay out a pattern of timing gates onscreen for a user,
activate the gates once a pattern has been selected or created by the user,
communicate wirelessly with the gates during a set-up process in a training area,
define a reference gate to start the pattern in the training area,
provide user guidance for placement of a set-up gate with respect to the reference gate,
provide user guidance for placement of further gates in the pattern, and
receive data from the gates during testing of an athlete.

25. A method of determining wind speed between sports gates, including:
setting up first and second gates having respective ultrasound transducers in a training area,
communicating by wireless between the gates and a supervisory device,
timing an ultrasound signal from the first gate to the second gate,
timing an ultrasound signal from the second gate to the first gate,
communicating timing data by wireless from either or both gates to the supervisory device,
calculating wind speed between the gates according to the timing data, and
calculating a measure of tailwind or headwind from the wind speed between the gates when using the gates for testing an athlete.

26. The method according to claim 25, further including:
setting up a third gate having a respective ultrasound transducer in the training area in relation to the first and second gates,
communicating by wireless between the first and third gates and the supervisory device,
timing an ultrasound signal from the first gate to the third gate,
timing an ultrasound signal from the third gate to the first gate, communicating timing data by wireless from either or both first and third gates to the supervisory device,
calculating wind speed between the first and third gates according to the timing data and distance between the first and third gates.

27. The method according to claim 26, further including:
determining a wind speed vector according to the wind speed between the first and second gates and the wind speed between the first and third gates, and the angle between the gates.

28. The method according to claim 27, further including:
setting up fourth and subsequent gates forming a pattern of gates in the training area,
calculating wind speed between multiple pairs of gates in the area, and
determining wind speed vectors in the area.

29. The method according to claim 25, further including:
timing multiple ultrasound signals between the pairs of gates in order to statistically eliminate wireless system latencies.

30. The method according to claim 25, further including:
correcting the timing data based on air temperature data measured at the gates.

31. A supervisory device containing a software application, wherein the software application includes instructions which enable the device to:
communicate by wireless with two or more gates in a sports training area,
cause timing of an ultrasound signal from a first gate to a second gate,
cause timing of an ultrasound signal from the second gate to the first gate,
receive timing data by wireless from either or both gates,
calculate wind speed between the gates according to the timing data, and
calculate a measure of tailwind or headwind from the wind speed between the gates when using the gates for testing an athlete.

32. A supervisory device according to claim 31, wherein the software application further enables the device to:
communicate by wireless between the first gate and a third gate,
cause timing of an ultrasound signal from the first gate to the third gate,
cause timing of an ultrasound signal from the third gate to the first gate, receive timing data by wireless from either or both first and third gates,
calculate wind speed between the first and third gates according to the timing data and distance between the first and third gates.

33. The supervisory device according to claim 31, wherein the software application further enables the device to:
determine a wind speed vector according to the wind speed between the first and second gates and the wind speed between the first and third gates, and the angle between the gates.
